(19) United States
(12) Patent Application Publication
(10) Pub. No.: US 2006/0190554 A1
(43) Pub. Date: Aug. 24, 2006

(54) Method, server and mobile terminal for checking interactions between a server application and a mobile terminal by creating a virtual assistant

(76) Inventors: Marquart Franz, Sauerlach (DE); Uwe Kruger, Munich (DE); Lars mehmann, Hohenbrunn (DE)

Correspondence Address: BELL, BOYD & LLOYD, LLC, P. O. BOX 1135, CHICAGO, IL, 60690-1135, US

(21) Appl. No.: 10/548,900

(22) PCT Filed: Feb. 25, 2004
(86) PCT No.: PCT/EP04/01877

§ 371 Date: Sep. 12, 2005

(30) Foreign Application Priority Data
Mar. 11, 2003 (DE) 103 17 756.6

(51) Int. Cl. G06F 15/16

(52) U.S. Cl. 709/217

(57) ABSTRACT

The invention essentially consists of a software component of a server application getting in contact with a software component of a mobile terminal during at least one connection, whereby generating a virtual assistant on the mobile terminal, and this virtual assistant controls interactions between the server application and the mobile terminal. The software components are consequently the extended hand of the manufacturer or provider, which optionally initiates the interactions and assumes the control over the time and sequence of interactions. Typical applications are notifications via telephone or network news, the user control for server applications and when monitoring payment processes.

### FIELD OF TECHNOLOGY

The present disclosure relates to a method, a server and a mobile terminal, in which a communication or interaction between a mobile telephone manufacturer or a mobile radio network operator and the user of a mobile terminal is influenced.

### BACKGROUND

Currently, communication or interaction between a mobile telephone manufacturer or a mobile radio network operator and the user of a mobile terminal is done only by specifically encoded SMS messages which, for example, make network-specific settings such as dial-in numbers in the telephone without consultation with the user. In addition, manufacturers and network operators can only send SMS or voice messages to the mobile telephone in the hope that the user reacts to these and initiates activities on their own account.

Much more serious are the provisions for downloadable content or useable services by the manufacturer/network operator for the mobile radio customers. Only a fraction of the users are currently aware of, or make use of these additional services as a result of the difficult procedures involved in their use. Specific services or content catalogs are in such cases only offered via portals which have to be actively interrogated by the user. In addition, the payment mechanisms make simple and fast provision of the corresponding service offerings difficult. Service offerings are today obtained via classical promotion channels, for example flyers and promotional SMSs and called up by the user via WAP portals.

In a number of cases it is advantageous for user interaction to be initiated and/or checked by a manufacturer or network operator.

### BRIEF SUMMARY

Accordingly, a method, a server and a mobile terminal are disclosed in which the interaction of a server application with a mobile terminal is improved.

A software component of a server application establishing contact during at least one connection with a software component of a mobile terminal is arranged so that a virtual assistant is created on the mobile terminal which controls interaction between the server application and the mobile terminal. The software components are thus extensions of the manufacturer or network operator which initiates the interaction if necessary and takes over control during the period of the interactions. Typical applications include notifications about telephone or network innovations, user control for server applications as well as supervision of payment processes.

### BRIEF DESCRIPTION OF THE DRAWINGS

The various objects, advantages and novel features of the present disclosure will be more readily apprehended from the following Detailed Description when read in conjunction with the enclosed drawings, in which;

FIG. 1 illustrates the interaction between a mobile terminal and a server, via a virtual assistant according to an exemplary embodiment.

### DETAILED DESCRIPTION

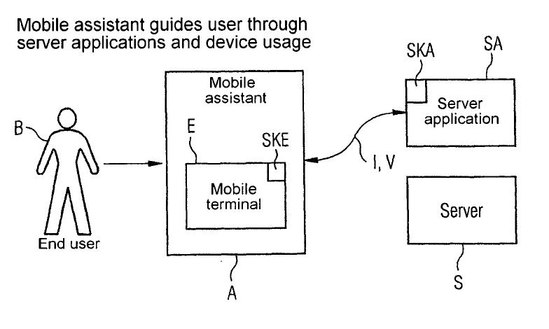

FIG. 1 shows an end user B with a mobile terminal E, as well as a server application SA on a server S, with a connection V being made between the server application and the mobile terminal. The mobile terminal E contains a software component SKE and the server application contains a software component SKA which are configured such that a virtual assistant A is created on the mobile terminal E, said assistant controlling or initiating the interaction I between the mobile terminal and the server application. The software component SKE is either integrated in addition to the operating system of the mobile telephone and the usual applications as part of the software core, or is permanently present in the form of pre-installed applications. Also, the software component SKE can be activated by the mobile telephone manufacturer or by the mobile radio network operator and forms a graphical interface for interaction between manufacturer or network operator and user of the telephone.

Under the exemplary embodiment, the software component SKA of the manufacturer or operator communicates with the software component SKE on the mobile telephone. These software components control the interaction of the manufacturer with the user and under some circumstances any use of the mobile telephone as well. Thus an almost exclusive communication between the manufacturer or network operator with the user may be established. For example, all further telephone calls except for emergency calls can be blocked until the prepaid account is topped up again. In this way it is even possible for manufacturer or above all network operator to remotely control applications on the mobile telephone and simultaneously the overall behavior of the telephone. This is important whenever there are events for which the user is not to have full control over the telephone.

Under the aforementioned configuration, manufacturers or operators can interact as soon as possible with the user and wishes to take the initiative in this interaction. The software component can be activated to interact exclusively with the user. Accordingly, manufacturers or operators can mostly dictate the time of the interaction themselves. Typical applications include system control, questionnaires and marketing/sales activities.

In other cases, the user may initiate an interaction with the manufacturer/network operator to seek guidance by the manufacturer/network operator during this interaction. Typical examples of this are the use of the answering machine and navigation through its menus, not by voice, but by means of graphical control. Furthermore, for critical actions such as money transfer, for example with prepaid accounts or micro payment with the mobile telephone, control can be left to the network operator or, with software updates, to the manufacturer.

The disclosed configuration can thus be used advantageously for the following exemplary applications:

1. Administration of prepaid accounts

2. Administration of the telephone mailbox or the answering machine

3. Payment transactions

4. Software updates

5. Telephone settings

6. Marketing/sales activities as part of the business model “Free minutes for promotional messages” and

7. Help for software and content download and installation/activation.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-10. (canceled)

11. A method for interacting a server application with a mobile terminal, comprising:
activating a software component of a server application; and
establishing contact via at least during one connection with a software component of a mobile terminal such that a virtual assistant is created on the mobile terminal which controls the interaction between the server application and the mobile terminal.

12. The method according to claim 11, wherein only the interaction is controlled by the assistant when the at least one connection is established.

13. The method according to claim 11, wherein actions and/or interactions are controlled by the assistant after the at least one connection is established.

14. The method according to claim 11, wherein the interactions are controlled by a graphical user interface with input prompts and/or selection menus.

15. The method according to claim 11, wherein the creation of the virtual assistant is initiated by the server application.

16. The method according to claim 11, wherein the creation of the virtual assistant is initiated by user entries at the mobile terminal.

17. The method according to claim 11, wherein a controlled communication between a manufacturer and the user of the mobile terminal is effected by the virtual assistant.

18. The method according to claim 11, wherein a controlled communication between the mobile network operator and the user of the mobile terminal is effected by the virtual assistant.

19. A mobile terminal, comprising:
a mobile software component; and
means for contacting a software component of a server application via said mobile software component, wherein a virtual assistant is created for control of interaction between the server application and the mobile terminal and in which the software component in the mobile terminal is present as part of a system core or fixed as a pre-installed application within said mobile terminal.

20. A server coupled to a communication network comprising:
a server software component of a software application; and
means for contacting a mobile software component in a mobile terminal via said server software component wherein a virtual assistant is created for control of interaction between the server application and the mobile terminal and in which the software component in the mobile terminal is present as part of a system core or fixed as a pre-installed application within said mobile terminal.
